(19) United States
(12) Patent Application Publication
(10) Pub. No.: US 2003/0200107 A1
(43) Pub. Date: Oct. 23, 2003

(54) System and method for cash management

(76) Inventors: Jeffrey L. Allen, Westport, CT (US); Donald R. Chiodo, Rowayton, CT (US); Barry S. Cohen, New York, NY (US); Phillip Evanski, New York, NY (US); Bryan Leggo, Bedford, NH (US); Paul A. Lindo, Rockville Centre, NY (US); Nicholas Lodowski, Millersville, MD (US); Glenn P. Murray, Riverhead, NY (US); Daniel Rosenbaum, Baltimore, MD (US); Aaron A. Smuts, New York, NY (US); Mark Cowan, Toronto (CA); Oliver Rist, West Orange, NJ (US)

Correspondence Address: SOFER & HAROUN, L.L.P., 317 Madison Avenue, Suite 910, New York, NY, 10017, US

(21) Appl. No.: 10/214,946

(22) Filed: Aug. 8, 2002

Related U.S. Application Data
(60) Provisional application No. 60/363,904, filed on Mar. 13, 2002.

(51) Int. Cl. G06F 17/60

(52) U.S. Cl. 705/1

(57) ABSTRACT

In accordance with one embodiment of the present invention a collection processing system comprises a payment service center that is configured to receive payments on behalf of a plurality of third parties, such as property managers and other parties expecting payments in return for their goods or services. The payment service center processes the payments, which includes scanning the payment that are typically in the form of checks or money orders, or other payment instruments. Each tenant or payer associated with a payment is identified, along with the building associated with that payment. A demand deposit account module (DDA X-Check) is set to first associate a payment to a corresponding tenant. A middle pass processor receives information relating to the payment made by tenant and determines whether the payment is to be accepted, based on a predefined set of acceptance and rejection rules that are applied based on the customer or tenant level, entity or building level and global or property manager level. The middle pass processor also determines whether certain payments are required to be reviewed by the property manager before acceptance or rejection. The information generated by the middle pass processor is then provided to a packet table processor, which generates instructions to the payment service center so as to process the received payments accordingly. As such, accepted payments are physically selected at the payment service center and carried to property manager's bank for deposit in a designated bank account. The returned payments are also physically selected for mailing back to the sender, or to the property manager's location. In accordance with another embodiment of the invention an automatic clearinghouse processor is provided to handle payments made by electronic means, such as credit cards, wire transfers, and third party payment processes.

### RELATED APPLICATIONS

This application claims the benefit of a provisional application serial No. 60/363,904, filed on Mar. 13, 2002, and is incorporated herein by reference.

### FIELD OF THE INVENTION

This invention relates to a system and process for automating payment collections by financial institutions, and specifically a rent collection system and process for use by property owners and managers.

### BACKGROUND OF THE INVENTION

Within the past two decades there has been an increasing effort to create cash management processing solutions for property owners and managers. There are many challenges associated with such efforts, because of the complex structures and arrangements involved in such applications.

For example, more and more property owners delegate the task of managing their properties to third party management companies who may handle many building and properties at the same time. A major task in such property management projects is collecting and processing rental payments.

Property managers need to comply with a plethora of internal and external rules or regulations, such as rent and housing laws, condominium and cooperative by-laws, and landlord policies. Many of these rules or regulations and policies also affect the criteria that need to be set for accepting payments from tenants. For example, many jurisdictions consider an acceptance of a rent payment as a waiver by the owner in an eviction proceeding. Furthermore, many property owners have their own internal policies to determine which payments to accept, which to reject and which to review directly by themselves. Many times these policies vary for each of the properties.

Property managers also receive payments in a variety of formats. For example, some tenants pay their rental payment by check in response to the rent statements that they receive. Other tenants pay by credit cards. Still other tenants pay by money orders. Some mail their payments, while others pay their rent by hand delivering it to a rental office. Other tenants pay by third party payment systems, such as CheckFree® or Quicken®.

In some instances a primary tenant may lease multiple units in a building. As such, the property manager may receive one rental check payment for all the units rented by the primary tenant. The task of determining and crediting the correct units may be time-consuming and prone to errors.

Furthermore, property managers utilize a plurality of various management software applications. The current systems do not provide for an arrangement that allows for an interface with a payment collection system, so that the underlying data relating to each of the utilized management software is consolidated and automatically updated, every time a payment is processed.

Thus, there is a need for a system and method for automating the entire payment or rent collection process from the initial step of receiving the payment, reviewing the payment for compliance with all requirements, and upgrading the property manager's underlying system information.

### SUMMARY OF THE INVENTION

In accordance with one embodiment of the present invention a collection processing system comprises a payment service center that is configured to receive payments on behalf of a plurality of third parties, such as landlords, property managers, and other parties expecting payments in return for their goods or services. The payment service center processes the payments, which includes scanning the payment that are typically in the form of checks or money orders, or other payment instruments.

An identification processor is coupled to the payment service center to receive information that identifies the third party, such as the property manager associated with a group of payments. It also identifies each tenant or payer associated with a payment, and the building associated with that payment.

A demand deposit account module (DDA X-Check (pronounced as “cross-check”)) is set to first associate a payment to a corresponding tenant. A middle pass processor receives information relating to the payment made by tenant and determines whether the payment is to be accepted, based on a predefined set of acceptance and rejection rules. The middle pass processor also determines whether certain payments are required to be reviewed by the property manager before acceptance or rejection. The information generated by the middle pass processor is then provided to a packet table processor, which generates instructions to the payment service center so as to process the received payments accordingly. As such, accepted payments are physically selected at the payment service center and carried to property manager's bank for deposit in a designated bank account. The returned payments are also physically selected for mailing back to the sender, or to the property manager's location.

In accordance with another embodiment of the invention an automatic clearinghouse processor is provided to handle payments made by electronic means, such as credit cards, wire transfers, and third party payment processes.

A plurality of computers employed by third party property managers are coupled to the collection processor via a communications channel, such as the Internet. Each computer includes one or more accounting software programs used by the corresponding property manager for handling the management of the properties that the manager is responsible. A data transfer module unit is provided to each computer so as to allow the collection processor to interface with the accounting software. To this end, the module generates a building master file, a rent billing file and a stop file that is updated by the property manager and the collection processor while processing the payments.

In accordance with another embodiment of the invention, a check/credit card reader is coupled to the property manager's computer, so as to allow tenants who walk in to the manager's office to make payments by presenting a check or a credit card. Pertinent information on the check or the credit card is read by the check reader and transmitted to the collection processor. Thereafter, the information relating to the checks or credit cards are converted into ACH (automatic clearinghouse) transactions in compliance with regulatory requirements such as those imposed by NACHA. The ACH and credit card transactions may also be entered manually into the system.

### BRIEF DESCRIPTION OF THE DRAWINGS

FIG. 1 illustrates a collection processing system in accordance with one embodiment of the present invention.

FIG. 2 is a coupon statement generated in accordance with one embodiment of the present invention.

FIG. 3 illustrates a payment service center in accordance with one embodiment of the present invention.

FIG. 4 illustrates a Criteria Template in accordance with one embodiment of the present invention.

FIG. 5 illustrates a check reader in accordance with one embodiment of the present invention.

FIG. 6 is a flow chart illustrating the flow of a payment received at a payment service center in accordance with one embodiment of the present invention.

FIG. 7 is a flow chart illustrating the process employed by the collection processor in accordance with one embodiment of the present invention.

FIG. 8 illustrates a screen employed to set up an Automated Clearing House (ACH) transaction in accordance with one embodiment of the present invention.

FIG. 9 illustrates a screen generated for an online review in accordance with one embodiment of the invention.

FIG. 10 illustrates an exemplary arrangement for an integration hub module in accordance with one embodiment of the invention.

### DETAILED DESCRIPTION OF THE DRAWINGS

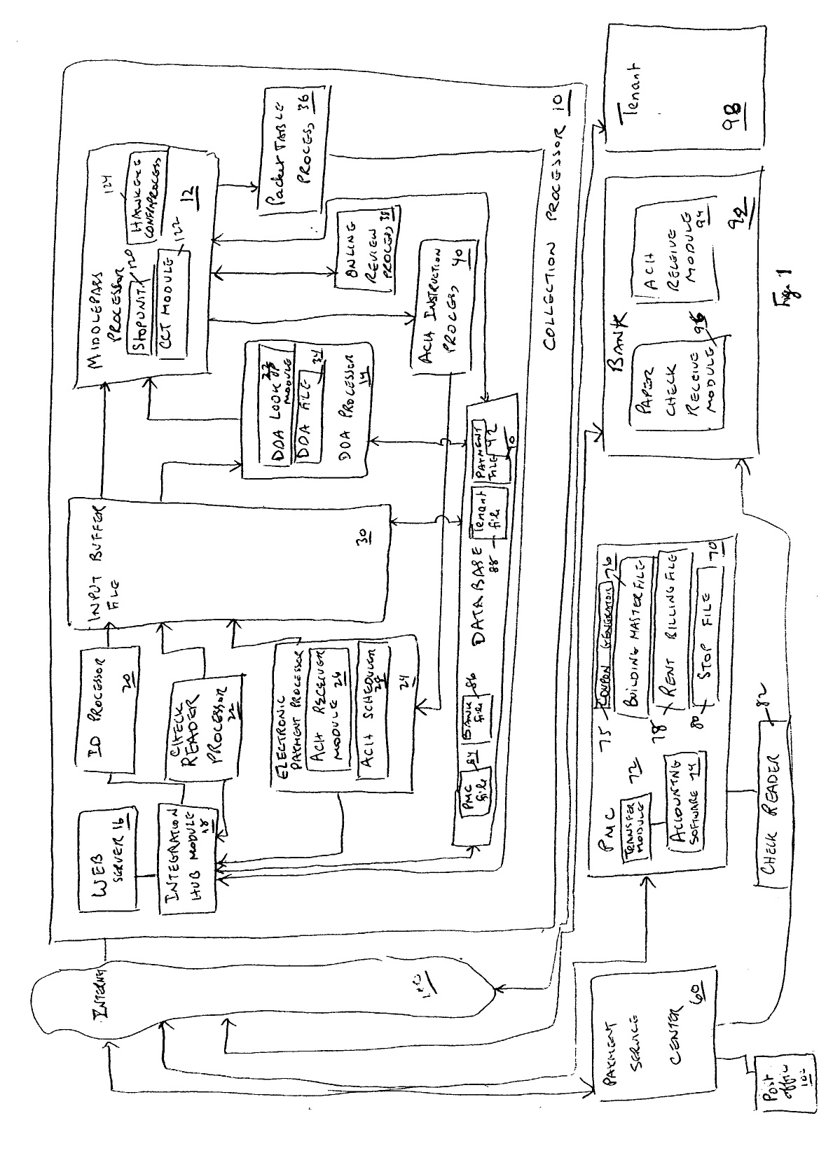

FIG. 1 illustrates a collection processor system 10 in accordance with one embodiment of the invention, although the invention is not limited in scope to the configuration illustrated in the Figure.

Collection processor 10 is configured to process payments made by a plurality of tenants, via various means, such as checks, money orders, wire transfers, credit cards, and third party payment systems.

It is noted that although the embodiment described in reference with FIG. 1 relates to a tenant collection process, the invention is not limited in scope in that respect. For example, the collection processor can be configured to process collections of payments for various other businesses that receive payments via a plurality of different means. Specifically, the collection processor can be configured to adapt to businesses that are assigned with the responsibility to receive payments from various customers on behalf of a plurality of other business owners.

Such businesses may include collection agencies, insurance agencies, credit card companies, mortgage management companies, and other financial institutions, referred herein as clients. Furthermore, the collection processor can be configured to allow each client to control and manage a plurality of entities, such as various outlets or branch offices.

In accordance with one embodiment of the invention, a collection processor 10 is employed to control, automate and manage the process of payment collection, for example in a real estate environment. A plurality of third party systems is coupled to collection processor 10, via Internet 110. Thus, within the context of a real estate environment, the clients may include management companies, the entities may include various buildings maintained by the management companies and the customers may include the tenants residing in each of those buildings. It is noted that within other contexts, for example a car dealership, the client may include a nationally operated car dealer, the entities may include each car dealership owned and operated by the car dealer and the customers may include the car buyers. In another context the clients may include banks, and each entity may include bank branches and the customers may include borrowers in each branch.

In accordance with one embodiment of the invention, the system may provide services to various clients at the same time. For example, clients may include a plurality of property management companies, along with utility companies, such as cable, telephone, water, gas and electricity providers, who subscribe to the same system for collection of their payments.

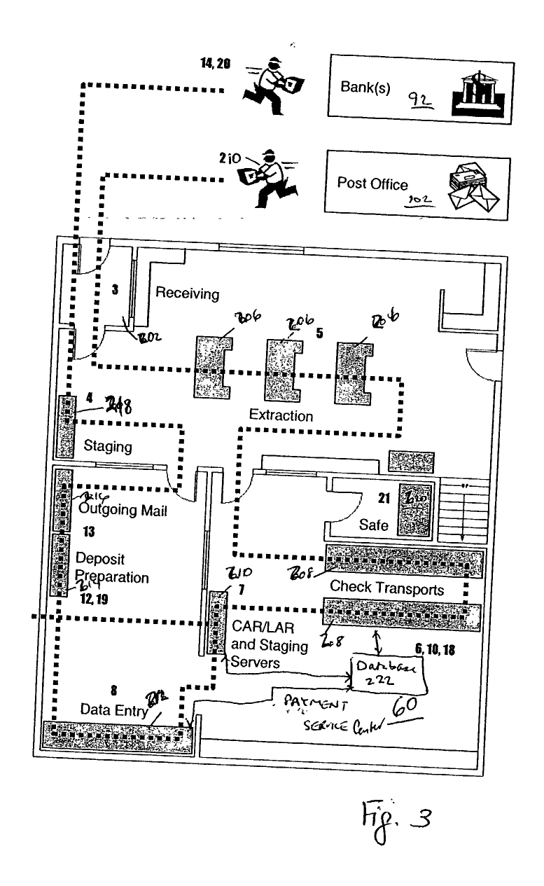

Thus, a payment service center 60 is employed to receive payments in the form of papers, such as checks and money orders, from various accounts or customers or tenants. Payment service center 60 receives the payments in batches and handles each batch separately, as will be explained in more detail in reference with FIG. 3. Payment service center 60 also makes a copy of each payment and stores the image and the corresponding data for later processing by collection processor 10 and further review by users of collection processor 10.

A plurality of property management systems 70 is also coupled to collection processor 10 via Internet 110. A property management system 70 is typically employed by a property management company, responsible to manage a property on behalf of an owner or a group of owners. For example, a building owner may retain a property management company to manage its building and collect rental payments made by the tenant. Similarly, a management board of a condominium or cooperative building may retain the property management company for the same purpose. Alternatively, a property owner may decide to manage its own property(ies) by implementing a property management system, such as 70.

It is noted that in many instances, the property management company may manage many properties on behalf of many owners. As such, property management system 70 is responsible to track all the transactions correctly and attribute each transaction to the corresponding building and owner.

In accordance with one embodiment of the invention, a check reader system 82 is coupled to property management system 70 so as to scan payment checks that have been provided to the property management company in person. The check reader is configured to scan and store the pertinent financial information printed on the check for further processing and submission to collection processor 10.

Property management system 70, in accordance with one embodiment of the invention, is a personal computer system that includes an accounting software system 74, which is typically a commercially available software system for property management, such as CTI, B. J. Murray, and RealmEnterprise, used for maintaining and tracking all aspects of a property management business.

System 70 includes a data transfer module 72 that is received from collection processor 10 so as to install all the necessary software code for allowing the property management system to interact with the collection processor, and to allow the information provided by the collection processor to be integrated and synchronized with information generated and stored by accounting software 74.

It is noted that in accordance with one embodiment of the invention, property management system 70 employs one or more accounting software systems 74. In that event, collection processor 10 is configured to store a consolidated version of all information received from each of the accounting systems, so as to provide the property management system with a choice of retrieving a consolidated form of information relating to all of the accounting systems, or retrieving information relating to each of the accounting systems.

Data transfer module 72 also creates a building master file 76, a rent billing file 78 and a stop file 80. Building master file 76 includes the identification of all the buildings handled by the property management company. Rent billing file 78 is configured to store every tenant's current outstanding balance and other pertinent billing and financial information related to the tenant. Stop file 80 is configured to store the information indicating whether a tenant's payment should be denied for the present billing cycle.

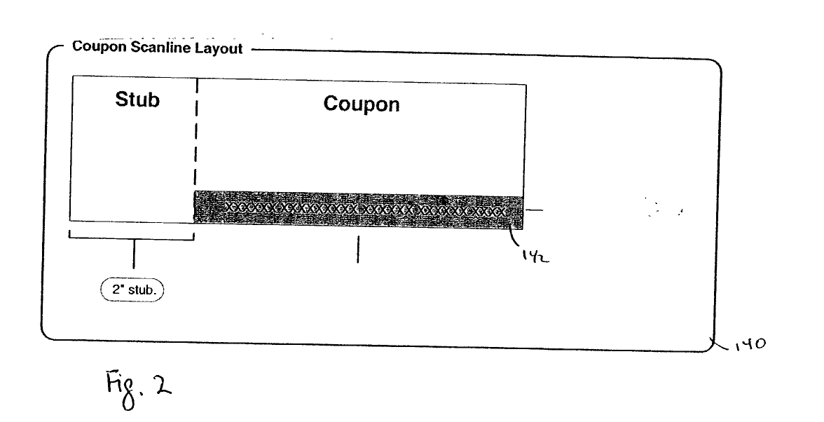

A coupon generator module 75 is configured to generate a coupon as illustrated in FIG. 2. The coupon includes a specified format with corresponding data fields that are arranged to include information, such as property management company name, tenant name, account number, billing date, amount due, and so forth. In accordance with one embodiment of the present invention, coupon generator module 75 sends the coupon information to a third party printer for printing the coupons on each billing cycle, rather than printing rent statements on a local printer coupled to the property management system.

Each property management system, such as 70, is assigned a separate P.O. Box number, by collection processor 10, so that the address used to mail the payments refers to the same location, except for the unique P.O. Box number, which identifies the property management system 70 and its corresponding property management company. This unique P.O. Box number is referred to as the lockbox number for that property management company. It is noted that in accordance with one embodiment of the invention, a unique mailbox number can be assigned to each property managed by the management company. In that event, a property management company may have many unique mailbox numbers assigned to it, each of which corresponding to a separate building.

With such an arrangement all the mail sent to each of the property management companies who employ the collection processor 10, is sent to the same location, and the P.O. Box number is used to differentiate between the property management companies and their corresponding managed properties.

A plurality of banking institutions 92 is also coupled to collection processor 10 via Internet 110. Banking institutions 92 are configured to receive paper checks for deposit directly from payment service center 60. Banking institutions 92 are also configured to receive information relating to automated clearing house (ACH) transactions based on instructions received from collection processor 10 as will be explained in more detail below.

A plurality of tenant terminals such as 98 is also coupled to collection processor 10 via Internet 110, in accordance with one embodiment of the present invention. As such, a tenant terminal 98 allows a user to view pertinent information of their payments as stored in collection processor 10. The tenant terminal, also allows the user to make on-line payments via third party sites.

It is appreciated by those skilled in the art that tenant terminals 98, in accordance with one embodiment of the invention, include a web browser software that is configured to communicate with collection processor 10 via the Internet. The functionality of various options for the tenant may be provided by collection processor 10, and specifically web server 16 of the collection processor.

In accordance with one embodiment of the invention, collection processor 10 includes a web server 16 that allows interaction with various third party systems via Internet 110. It is noted that the invention is not limited in scope in that respect and collection processor 10 can communicate with other systems via any available communication channel in accordance with other embodiments of the invention.

Collection processor 10 also includes an integration hub module 18 that is configured to receive data files from various users, such as property management systems 70. Integration hub module 18 transmits the corresponding to a data transfer 72 to the property management systems so as to allow exchange of information between collection processor 10 and the financial management software employed by the property management system.

Integration hub module 18 translates or passes through the received data files into a proper format for use by collection processor 10, after it determines the validity and source of the data files, as will be explained in more detail hereinafter in reference with FIG. 10. It is noted that although integration hub module 18 is illustrated as a component of collection processor 10, the invention is not limited in scope in that respect. For example, module 18 may be located remotely from collection processor 10.

Collection processor 10 also includes an identification (ID) processor 20, which is configured to receive and extract the identification information relating to the data and image information provided by payment service center 60 regarding each of the payments received by payment service center 60. This information, in accordance with one embodiment of the invention, includes the identification of the property management system responsible for each particular payment, the tenant information corresponding to the payment, the building information corresponding to the tenant, and the deposit account number to which the payment must be credited.

ID processor 20 is coupled to an input buffer file 30, which is configured to temporarily store the information received from the ID processor for further processing.

Collection processor 10 also includes a check reader processor 22, which is coupled to integration hub module 18. Check reader processor 22 is configured to receive and extract information relating to checks scanned by check reader 82 at the property management company's location. It is noted that check reader processor 22 in accordance to one embodiment of the invention is configured to receive scanned credit card information.

The information relating to the scanned items includes the identification of the property management system responsible for a particular payment, the tenant information corresponding to the payment, the building information corresponding to the tenant, and the deposit account number to which the payment must be credited. Check reader processor 22 is also coupled to input buffer file 30, for temporary storage of the information and later processing. It is noted that although check processor 22 is illustrated as a component of collection processor 10, the invention is not limited in scope in that respect. For example, check processor 22 may be located locally with property management system 70.

Collection processor 10 also includes an automatic clearing house (ACH) processor 24, which is configured to handle payments made via electronic means, such as wire transfers, credit card transactions, third party electronic payment arrangements, and periodical account withdrawal arrangements. Electronic payment processor 24 includes an ACH receiver module 26 and an ACH scheduler module 28. As will be explained in more detail hereinafter, ACH receiver module 26 is configured to process ACH payments authorized by tenants. For example, module 26 generates instruction files that are transmitted to banking institutions for fund withdrawals on behalf of an account owner tenant. ACH scheduler module 28 is configured to track and act upon periodic ACH payments, as authorized by a tenant and in compliance with regulatory requirements, such as those imposed by NACHA, which is an electronic payment association that among other things, provides rule making for ACH and other electronic payment systems.

Electronic payment processor 24 is also coupled to input buffer file 30, so as to transmit its generated information to the buffer file for later processing by collection processor 10.

Collection processor 10 includes a middle-pass processor 12 that is configured to analyze the payments made by a tenant so as to approve or deny such payments, and to provide an image of the information concerning the payment to the appropriate property management system for an on-line review process as will be explained in more detail hereinafter.

Collection processor 10, and in particular, middle pass processor 12 includes a stop unit 120, which retrieves the payment approval information relating to a tenant, so as to determine whether a payment made by a particular tenant is acceptable or not. The payment information is then tagged with the information provided by stop unit 120.

Middle-pass processor 12 also includes a check criteria template (CCT) module 122, which is configured to retrieve the criteria specified by a property owner and/or the property management company for accepting, rejecting or flagging a payment. These criteria include a list of conditions upon which a payment is either accepted or rejected, or provided for on-line review by the property management company.

Middle-pass processor 12 also includes a payment confirmation processor 12 (Hawkeye™ processor) that is configured to provide a confirmation flag so that once a payment is actually processed a confirmation signal is sent to the property management system.

A demand deposit account (DDA) processor 14 is also coupled to input buffer file 30 and middle-pass processor 12. DDA processor 14 includes a DDA look up module 22, which is configured to determine whether a received payment can be attributed to a previously identified tenant, whose information has been stored by collection processor 10. DDA processor 14 also includes a DDA file module 34, which is configured to interact with a property management system, such as 70 to allow a property manager to set up a DDA identification for a tenant.

Collection processor 10, also includes an on-line review processor 38 coupled to middle-pass processor 12, configured to receive instruction signals so as to enable a property management system to review the details of a payment on-line for approval or rejection.

Middle-pass processor 12 is also coupled to an ACH instruction processor 40, which is configured to receive instruction signals so as to prepare ACH instruction files for transmission to a desired banking institution to process an ACH payment.

Middle-pass processor 12 is also coupled to a packet table processor 36, which is configured to receive appropriate information for transmission to payment service center 60, so as to allow the operators at payment service center 60 to transport to and deposit in the banks, the checks accepted for payment. The checks that have not been accepted for payment are sent to property management companies for retaining or returning to the sender.

Collection processor 10 includes a database system 42, which is configured to store all the system's pertinent information. Thus, database system 42 includes a property management company (PMC) file 84, which is configured to store all the relevant information relating to each of the property management companies employing processor 10. This information includes the property management company's specific business rules as set forth in a Check Criteria Table (CCT), which defines the rules that need to be applied to each received payment.

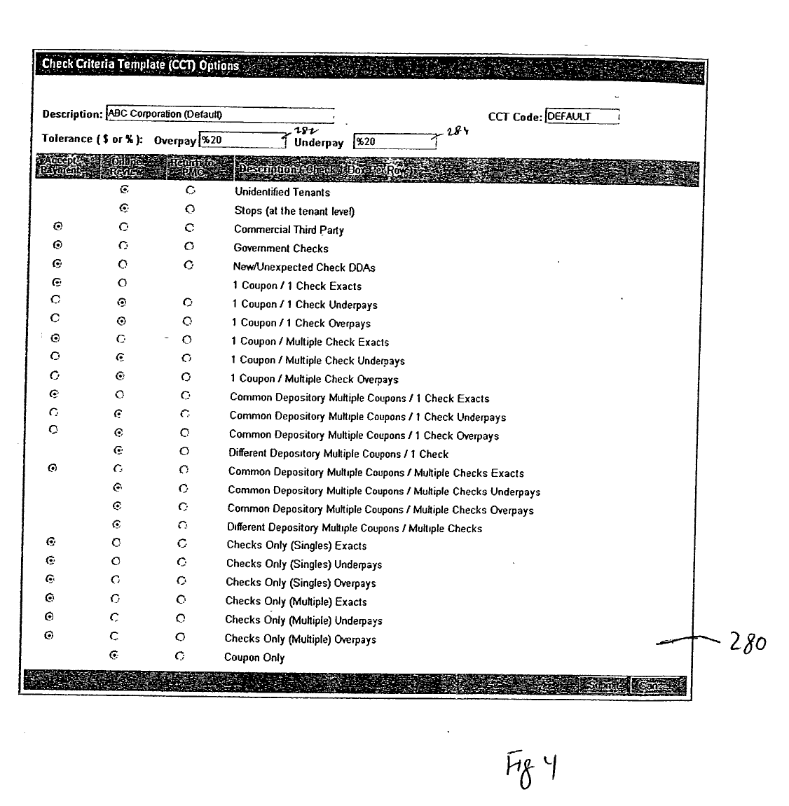

FIG. 4 illustrates an exemplary CCT table 280 in accordance with one embodiment of the present invention. Typically, table 280 includes four fields, the first three of which are desired action comprising “accept payment,” “on-line review,” “return to PMC (property management company),” and the forth field is a payment scenario “Description for Each Action.”

A property management company specifies one of the three desired actions for each corresponding payment scenario. For example, if a received payment is from an unidentified tenant, a property management company can select either an “on-line review,” or “return payment to PMC.” This rule gets incorporated in the CCT table 280 for the property management company. It is noted that for a management company that manages more than one property or more than one owner, a separate CCT table can be set up for each property, for each owner and for each tenant. Furthermore, a CCT table can be constructed that includes rules on a tenant level, on a building level, and on a property management level.

In accordance with another example, a property management company may desire a specific action on a tenant level. For example, if a stop is indicated for a tenant, CCT table provides the desired action for such stop scenarios. One option is to provide the payment for on-line review, and the other option is to return the payment back to the property management company. This rule is specifically important for jurisdictions that waive an eviction claim against a tenant, if the tenant's payment has been accepted.

Other examples include payments that are paid by a commercial third party, by government checks, new or unexpected check DDAs. In each instance, a property management company determines whether to accept the payment, review the payment or to receive the payment without depositing it.

CCT table 280 also includes an overpay tolerance field 282 and an underpay tolerance pay 284. Each field includes an amount, either in percentage or actual dollar amount, by which a payment may exceed or fall short of the billed amount.

Other examples of the business rules as illustrated in FIG. 4 include the various ways a payment is made. For example, one scenario is that a payment is received with an accompanying payment coupon. If the amount is correct, the property management company more than likely would select the “accept payment” option. If however, there is an under or over payment, the property management company would likely select the “online review” option. Another scenario is when the payment is made by multiple checks and is accompanied by one coupon. The likely option to select is “accept payment.”

In another set of example, there may be one payment that is made for multiple units that are managed by the same property management company. In that event, a payment may be received with multiple coupons. Depending on whether the payment is exact, or underpaid or overpaid, the property management company may decide to respectively accept or review the payment online before accepting or rejecting. In another scenario, multiple payments may be received with accompanying multiple coupons.

In yet another example, a payment may be made without an accompanying coupon. If so, as will be discussed further, the system determines whether the information on the check can identify the payer or the corresponding unit resident, and if so the payment may be accepted or processed for online review.

In accordance with one scenario, a correspondence may be received that includes a coupon but no payment. The system may then provide the coupon for online review.

Database system 42 also includes a banking file 86, which is configured to store all the relevant information relating to each of the banks specified by property management system and the tenants making the payments.

Database system 42 also includes a tenant file, which is configured to store all the relevant information relating to each of the tenants managed by the participating property management systems. This information includes the tenant DDA (demand deposit account) information, which is the information provided on the tenant's check, and is used to associate a check received on behalf of a tenant, with the tenant's identification and bank account information. Tenant file also updates its information based on the information provided and contained in rent billing file 78 of the corresponding property management company.

Database 42 also includes a payment file 70, which is configured to store all the relevant information relating to each payment, for example, whether the payment made by a tenant should be accepted or not.

As mentioned above, in accordance with one embodiment of the invention, for property management systems that employ more than one accounting system, data transfer module 72 retrieves from each accounting system the pertinent information necessary to update the building master file, the rent billing file and the stop file, so that the information contained in each of these files forms a consolidated version of the information in each of the individual accounting systems. The consolidated information is then send to collection processor 10 for storage in database 42. In the alternative, collection processor 10 is configured to consolidate all the information it receives from a property manager that employs more than one accounting system. This allows a property manager to retrieve information, for example, the account receivables for all properties managed, on a year-to-date or month-to-date basis, or the account receivables for a particular building, or a particular tenant, or those pending for on-line review.

FIG. 2 illustrates an exemplary payment coupon that is generated by property management system 70 in accordance with one embodiment of the invention. For each billing cycle or more often if desired, property management system 70 retrieves the information necessary from rent billing file 78 and building master file 78, to generate the information relating to the payment coupon. This information is then provided to coupon generator 75, so as to generate printing instruction information that is provided to an on-site or an off-site printer. It is noted that coupon generator 75 may be located at collection processor 10. The information necessary to generate coupons can then be forwarded to the collection processor for causing coupons to be printed and mailed to each tenant as set forth by the property management company.

Coupon 140 includes a scanline 142 which in accordance with one embodiment of the invention is 5.5″ wide and located ½″ from the bottom of the coupon. Scanline 142 includes coupon data fields that contain information relating to a payment. Therefore a field is used for identifying the property management company name and address. A second field is used for identifying the tenant's name and address. An account number field is used for identifying the account number related to a tenant. Another field is used to identify the billing date related to a billing cycle. Another field contains information for payment, for example “Please make checks payable to” field. The next field identifies the due date for the payment. Another field identifies the amount due. And still another field provides a two-line user-definable comment information.

The field identifying the property management information, in accordance with one embodiment of the invention includes 9 positions, each representing a byte that contains the post office box number assigned to a property management company and the corresponding 4 digit zip code. Positions 10-27 in the scanline contain building number info, and tenant number info. Positions 28-35 in the scan line contain the invoice number corresponding to the payment. Position 36 includes a check digit byte that validates that the scanline is properly formatted. Position 37 contains the suspense flag information, wherein P=process the payment, O=provide on-line review and R=return payment to the property management company. Typically, at the beginning of each billing cycle, information relating to the coupons is generated so that payment coupons are property printed for distribution to the tenants.

FIG. 3 illustrates an exemplary payment service center 60 in accordance with one embodiment of the invention. Payment service center 60 is a physical location, wherein all paper payments handled by collection processor 10 is processed. It is noted that although FIG. 1 illustrates one center 60, a plurality of such payment service centers can be employed in accordance with other embodiments of the invention.

As illustrated in FIG. 3, payment service center 60 is located in a close proximity to a post office 102. Post office 102 can be any desired post office and need not be in a close proximity to the management company. As such, paper payments can be processed at a geographical region remote from the property management company, for example to lower labor costs.

Payment service center 60 receives batches of paper payments, such as checks and money orders, preferably with their corresponding coupons 140 via messengers 210. Payment service center 60 includes a receiving station 202, which is configured to collect the received mail. It is noted that the mail will be received by center 60 in batches, each of which relating to a unique P.O. Box number that is assigned to a particular property management company.

Payment service center 60 includes one or more extraction stations 206, which are configured to open the mail relating to each batch. A unique batch header document is provided by extraction station 206, with a unique batch identification information for each received batch. The batch header document also includes a work source number that identifies the corresponding property management company and its desired sorting instructions as will be explained hereinafter. The sorting instructions provide information as to how each payment should be handled. Thus, for each property management company, the sorting instructions determine the route of those payments within payment service center 60, that are accepted and need to be delivered to the banking institution, and the route of those payments within payment service center 60 that are required to be held for review, and the route of those payments that are required to be sent to the property management company.

A check transport system 208 is configured to receive the extracted and batched mail. In accordance with one embodiment of the invention, check transport system 208 is a commercially available device such as NCR 7780 transport system that is employed for mail sorting operations. Typically, the check transport system 208 includes a plurality of sorting pockets. The mail received by payment service center 60 is loaded on check transport system 208 at least twice during two passes.

At the first pass, check transport system 208 reads and scans the information on each received payment, for example check or money order. Thus, an image of the front and back of a check is captured, and the corresponding information contained on the coupon scan line is read. The data on a check MICR line is also read. This is the data that provides the bank information and routing number and the check number and the payer's account number. Each captured check and its corresponding coupon receives a unique sequence number to identify the check and the coupon in a particular batch. Transport system 208 then prints the unique batch and sequence number on each received check or payment.

Scanned and processed checks are then transported to recognition system 610 that is configured to recognize the character amount on the check (amount numerals) and the legal amount on the check (the written amount portion).

A manual data entry module 212 is provided and is configured to display images of each check that its corresponding information was not successfully recognized by recognition system 210. An operator then manually inputs the unrecognized information via data entry system 212. Data entry system 212 is also configured to conduct a balancing procedure, which advantageously compares the amount set forth on the coupon information with the amount actually paid.

A deposit preparation stage 214 is provided and configured to prepare deposit slips for all those payments, for a property management company, that are accepted for deposit.

During the second pass, payment service center 60 then awaits instructions from collection processor 10 to load the pockets in check transport system 208 according to sorting instructions generated by processor 10. Thus, those payments that are accepted for deposit are properly loaded on check transport system 208 and provided to deposit preparation stage 214. Other payments that are to be held for on-line review are sent to a safe deposit system 220.

Safe deposit module 220 is provided so as to receive each batch and its corresponding checks and coupons that need to be reviewed by the corresponding property management company.

A database system 222 is configured to store all the check images and corresponding information as provided by check transport system 208, recognition module 210, and data entry system 212.

Payment service center 60 includes a staging module 218 for sorting and logging all payments that need to be delivered to banking institutions 92. Payment service center 60 provides the payments to a banking institution such as 92, for each corresponding batch of payments that have been accepted for payment.

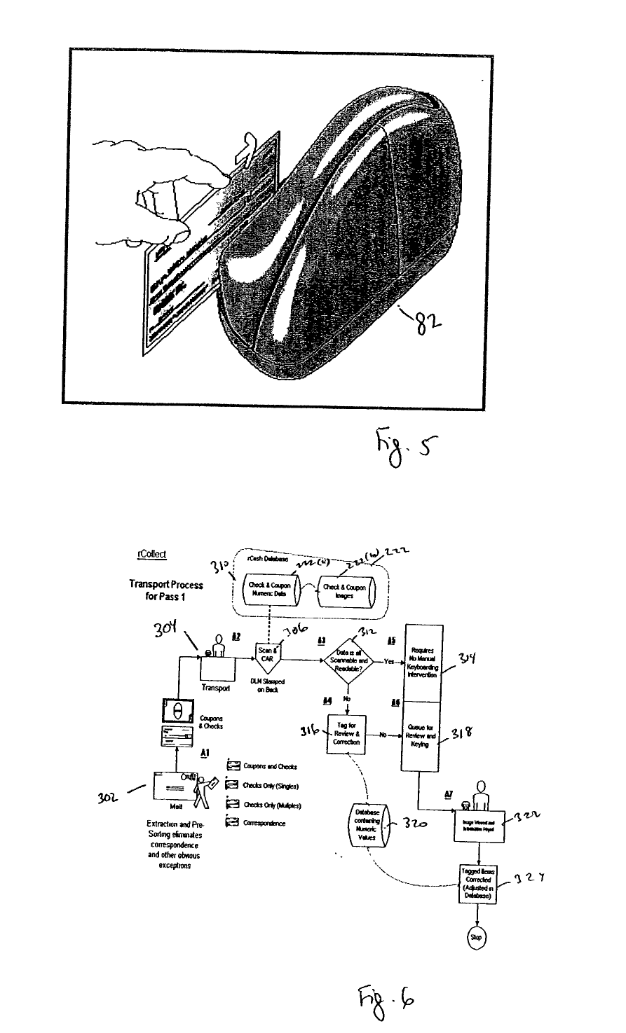

The operation of check reader 82 is described in more detail in reference with FIG. 5. Check reader 82 is employed in situations wherein a property management company receives a check or a credit card from a tenant, and desires to incorporate the payment with the operation of collection processor 10. Check reader 82 scans an image of a check payment and provides that information to ACH (automatic clearing house) processor 24 for withdrawal from the check's bank account and deposit to the property management company's bank account.

Check reader 82 may be employed in at least three types of automatic clearing house (ACH) transactions. First, in a check conversion process, a tenant provides a check in person with a check to pay the rent. To this end, the property management company stamps the back of the check with the required ACH language, including the address of the property management company, with the tenant's signature. The property management company, thereafter scans the front and the back of the check. The scanned information from check reader 82 is then forwarded to Electronic payment processor of the collection processor 10.

In accordance with another embodiment of the invention, a tenant sends a check to the property management company instead of the designated P.O. Box number that forwards the payment to payment service center 60. In response check reader 82 is employed to scan the check in an arrangement similar to the scanning process described above. Once the image of the check is stored in property management system 70 and thereafter forwarded to collection processor 10, the received check is destroyed. Electronic payment processor 24 handles the automated payment on behalf of the property management company.

In accordance with yet another embodiment of the invention, the property management company sets up a tenant for recurring ACH processing. A tenant's check is scanned and property management system 70 is instructed to process the payment on a periodical basis, for example every billing cycle.

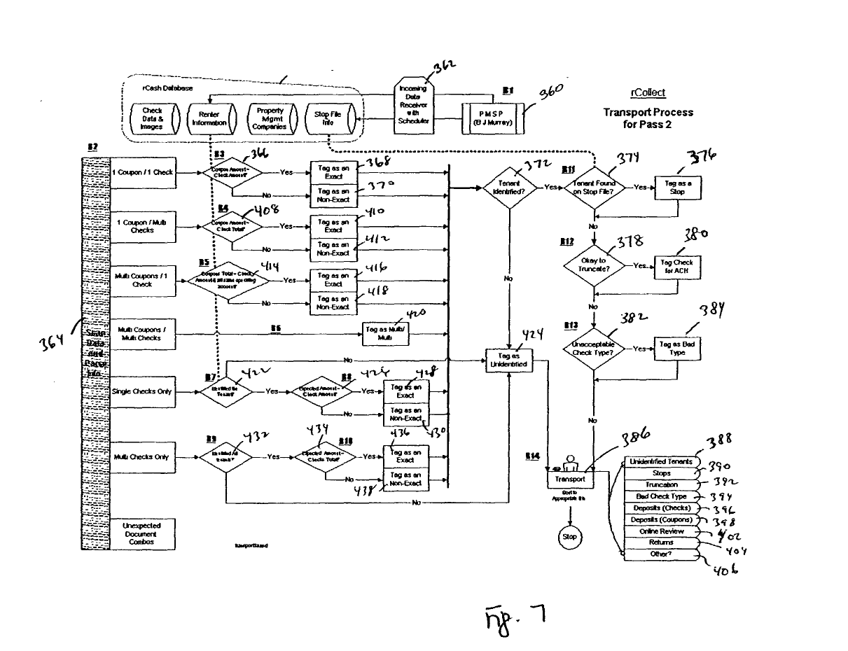

FIG. 6 is a flow diagram illustrating the process embodied by payment service center 60 in accordance with one embodiment of the present invention. Thus at step 302, once the payments are received at the payment service center, the envelops are opened for payment extraction and presorting. All items other than checks and coupons, such as correspondence and metal objects such as staples, paper clips, etc. are first sorted out. Thereafter, the envelopes are discarded. However, in accordance with one embodiment of the invention each envelope with its corresponding payment and coupon content is sorted for placement on check transport bins 208 (FIG. 3).

At step 304, each coupons and corresponding check/s is scanned and a sequential identifier is printed on the back of each item to log the item. The identifier includes a site number that identifies the location of the payment service center. The identifier also includes a processing date information, envelope number information and a sequential number. The scan line on each coupon is then read as explained before in reference with FIG. 2. On each check, the transit routing number, account number (DDA), and check number are read.

The documents are then sent to CAR/LAR recognition module 210 (FIG. 3) to read the Courtesy Amount and Legal Amount respectively at step 306.

At step 310 database 222 stores the information obtained by recognition module 210, including check and coupon data in database 222a and check and coupon images data in database 222b.

At decision step 312, payment service center 60 determines whether the data scanned is all readable for storage. If so the system goes to step 314, and identifies the data as requiring no manual keyboarding intervention.

If however, the data is determined to be not readable at step 312, the system goes to step 316 and the corresponding item is tagged for review and correction. Thereafter, the scanned image corresponding to the item is retrieved from database 222 and queued for manual review by a human operator. At step 320, a temporary database for receiving the manually entered numeric values corresponding to the item is set up. At step 322 the human operator reviews the image of the item and types in the numeric values of all fields that were not recognized at the scanning and recognition module 210. At step 324, the database entry for the corrected data is updated. Thereafter, payment service center 60 awaits the second pass to be processed by middle pass processor 12 (FIG. 1) so as to instruct the handling of the checks and coupons received by center 60.

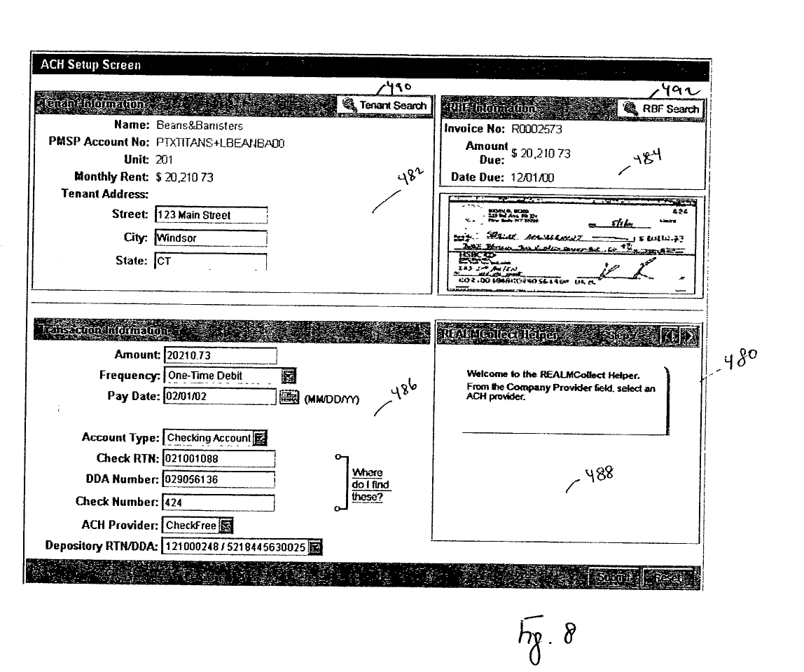

FIG. 7 is a flow diagram illustrating the process employed during the second pass in accordance with one embodiment of the invention. At step 360, each property management company 70 sends its corresponding rent billing file, building master file, which includes each tenant's DDA and Stop file, which includes the list of tenants from which a payment is not to be accepted for a current billing cycle. This information then updates database 42 of collection processor 10 (FIG. 1). Meanwhile, at step 362, each payment service center 60 transmits the images and information corresponding to each payment received so as to update database 40 and payment file 42 (FIG. 2).

At step 364, image and data files corresponding to the payments scanned at payment service center 60 are sent to ID processor 20, so as to identify the work source number of a received batch and its corresponding property management company, and tenant and building information. The records received by ID processor 20 are then categorized based on the combination of coupons and checks received in each payment. Thus, if a payment contained one check and one coupon the system goes to decision step 366 to determine whether the coupon and the check amounts are the same. If so the system goes to step 368 to tag the work source number as exact. Otherwise the system goes to step 370 to tag the work source number as non-exact.

The information is then queued up in input buffer file 30 for further processing by middlepass processor 12. At decision step 372 the system employs DDA processor 14 to determine whether the tenant information corresponds to an identifiable tenant based on the information stored in database 10. Basically, DDA processor 14 analyzes the DDA number of the check received with the payment and determines whether a tenant has been already associated with that DDA number.

At step 374, middlepass processor 12 retrieves the tenant information provided by DDA processor 14. Processor 12 also retrieves the corresponding Check Criteria Template (CCT) and stop file from database 42. It is noted that in accordance with one embodiment of the invention middle pass processor 12 and CCT module 122 before loading a corresponding CCT first determine whether a special Criteria Template for the identified tenant exists. If so, the tenant CCT is retrieved in order to apply the desired rules. If not, CCT module 122 determines whether a special Criteria Template for the particular building exists. If so, the building CCT is retrieved in order to apply the desired rules. Otherwise, CCT module 122 retrieves the CCT table attributable to a desired lockbox that corresponds to a property management company.

Thereafter, middlepass processor 12 determines whether the stop file includes the identified tenant. If so, the system goes to step 376, and tags the payment as a “stop,” which results in not depositing the payment.

If at step 374 it is determined that the stop file does not include the identified tenant, the system goes to step 378 to determine whether it is possible to truncate the payment received from the tenant. This means that collection processor 10 can process the payment via Electronic payment processor 24, instead of instructing payment service center 60 to deposit the check payment physically in a designated bank. The instruction to truncate can be provided by either the tenant via tenant terminal 98, or tenant's authorization via property management company 70, or via check reader 82, when a check is processed via the reader as explained above in reference with Fig..

At step 382, middle pass processor 12 applies the criteria set forth in the retrieved CCT table to determine whether the received check type is acceptable or not. If not, the system goes to step 384 and the payment is tagged as unacceptable.

Thereafter, the system goes to step 386 to receive the information as generated by packet table process 26. Packet table process 26, based on the analysis performed by middle pass processor 12 provides instructions as to how to handle each payment in payment service center 60. Some of the exemplary bins that the payment may be ultimately forwarded is category 388 for unidentified tenants, 390 for stops, 392 for truncation, 396 for checks to be deposited, 398 for checks accompanied with coupons for deposit, 402 for payments that need to be provided for on-line review, 404 for payments that need to be returned to sender, and 406 for other categories.

If at step 364, ID processor 20 determines that the received payment contains one coupon and multichecks, the system goes to step 408 to determine whether the coupon amount matches the total amount of the combined checks. If so, the system goes to step 410 and the payment is tagged as exact. Otherwise, the system goes to step 412 and the payment is tagged as non-exact. Thereafter the system goes to step 372 and undertakes the same steps discussed above in reference with steps 372 through 406.

For payments that contain multiple checks and multiple coupon pertaining to various tenants who should be processed according to different set of business rules and set forth in a corresponding CCT table, the payment is categorized as unexpected document combinations and the system goes to step 428, so that the envelope is either put on-line for review or returned according to the CCT involved. This decision overrides any of the multiple coupon scenarios discussed below.

Thus, if at step 364, ID processor 20 determines that the payment contains multiple coupons and one check the system goes to step 414 to verify whether all coupons are associated with a common depository account, i.e., the payment is going to the same property management company (PMC) operating account. If so, then the system at step 414 determines whether the check amount is equal to the total amount of all the coupons to determine whether there is an exact match. If so the system goes to step 416 and tags the payment as exact. Otherwise, the system goes to step 418 and tags the payment as non-exact. Thereafter the system goes to step 372 to follow the steps 372 to 406 as described before. It is noted that when the system takes into consideration the tolerances set for overpay and underpay, when determining whether the amount of the check is exact or not. Furthermore, if the coupons are with different depository accounts the system then applies the special rule for different depository accounts.

If at step 364 it is determined that the payment arrived with multiple coupons and multiple checks, the system goes to step 420 to tag the payment as such. The system then determines that the coupons are associated with the same depository account, meaning that the payments are intended for the same PMC operating account. Furthermore, the system determines whether the total amount on all payments, such as checks, money orders, etc. are equal to the total amount indicated on all the coupons, taking into account the underpay and overpay tolerances for a particular payment. Thereafter the system performs steps 372 through 406 as explained above.

In accordance with one embodiment of the invention, if at step 364 it is determined that the payment arrived with checks only, without any coupons, the system first attempts to identify the tenant, based on the information contained on the payment. At step 422, DDA processor 14 enables DDA look up module 22 to search DDA file 34 based on the TRN and DDA numbers printed on the check. If at step 422 there is no match or more than one matching TRN/DDA combination on file then the check ownership is ambiguous and the payment is marked as unidentified at step 424. Thereafter, at step 386 payment service center 60 places the item corresponding to the payment, in the unidentified tenant bin 388 for on-line review by the property management company.

If however, at step 422 the tenant is identified based on the matching DDA number of the check and the DDA information previously stored for the tenant, CCT module 122 retrieves the appropriate CCT table for that tenant, which may include all rules applicable to that tenant, the tenant's building and the tenant's property management company.

Furthermore, once the tenant is identified, the rent payment for the corresponding billing cycle is retrieved from database 42 so as to create a virtual coupon for storage in tenant file 88. At step 426 the check amount is compared to the expected rent amount and if it matches—based on overpayment and underpayment tolerances—the system goes to step 428 and tags the check as exact. Otherwise it goes to step 430 and tags the check as non-exact. Thereafter, the system goes to step 372 so that middlepass processor 12 applies the rules set forth in the corresponding CCT table as explained before in reference with steps 374 through 406. Thus, if the application of the rules as set forth in the CCT table results in Accept payment or Return to PMC then payment service center 60 sorts the check to forward it to either the designated bank for deposit or return to the PMC. If the application of the rules as set forth in the CCT table results in Online Review, then a PMC representative will be required to review the image of the check to make a decision on its status and if the tenant was unidentified, assign a tenant to the check.

If at step 364, it is determined that the payment included multiple checks only, the system goes to step 432. If any one of the payment documents is not a standard check then the items in the envelope are marked as unidentified tenant. Non standard checks include money orders, third party checks, etc.. Standard checks include personal or business checks, commercial third party checks issued on behalf of a tenant, such as those provided by CheckFree corporation, or government checks issued on behalf of a tenant for welfare or subsidy purposes. It is possible to set the CCT table so that all or some of these types of checks are acceptable and some are not.

At step 432 the DDA processor determines whether it can identify all the checks or not. If at step 432 any of the checks is non-standard or it is not possible to identify all of the checks, the system then goes to step 424 to tag the payment as unidentified. Thereafter packet table process 36 sets forth the proper instructions to be transmitted to payment service center 60 so as to place the payment documents in their proper bin as specified in steps 388 through 406.

If at step 432, DDA processor 14 determines that all the received checks are identifiable, the system then goes to step 434. For all checks that are attributed to one tenant, the system then adds the amount and determines whether the amount is exact or not after considering the thresholds for overpayment and under payment. The system then at step 436 tags the payment as exact for each check or checks that total to the expected amount. Otherwise, the system at step 438 tags the payment as non-exact for each check or checks that do not total to the expected amount.

Thereafter, the middle pass processor employs steps 372 through 406 for each identified tenant, by applying the criteria set forth in the corresponding CCT table for each identified tenant.

In accordance with one embodiment of the invention, online review processor 40 allows a property management company operator review payment documents that have been set aside for review by middle pass processor 12.

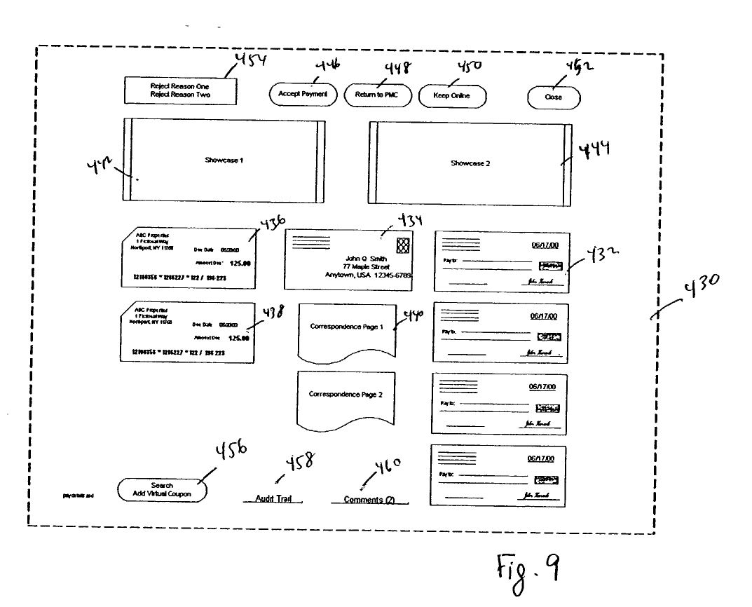

FIG. 8 illustrates a detailed transaction screen 430, which is generated by online review processor 40 as a user interface for online review interactions. Transaction screen 430 is employed to show the status of documents within each received envelope including the rules applied in accordance to the corresponding CCT table during the second pass. Transaction screen 430 is also used to finish processing items in Online Review mode.

Transaction screen 430 contains thumbnail representations of each document to reduce bandwidth. Each thumbnail representation contains a representation or icon for each type of document and also contains key data fields derived from that document. For example, a check icon 432 may be in the standard format of a paper check with embedded dollar, transit routing and DDA numbers located on their expected locations on a check. A different thumbnail icon 434 is employed to represent envelopes. Similarly an icon 436 is used to represent actual coupons, and icon 438 is used to represent virtual coupons. An icon 440 represents a correspondence page and so forth.

As explained before, system generated coupons or virtual coupons are generated when actual physical coupons are missing in a received envelope. Both actual and virtual coupons display tenant and account information, amount due and deposit information concerning the property management company. In accordance with one embodiment of the invention, interface screen 430, enables a property management company to interact with coupon generator 75 so as to generate virtual coupons corresponding to checks received in a payment.

In accordance with one embodiment of the invention thumbnail colors relating to items that have been Accepted or Returned are grayed-out to indicate that the items cannot be processed any further.

Once a thumbnail is clicked or dragged to a designated area such as showcase field 442 and showcase field 444, the actual image associated with that document is displayed. Images default to their front view and the orientation is retained if the user shifts between different documents. The default image for the showcases is the first coupon and the first check image, which corresponds to the most common single/full pay scenario. In accordance with one embodiment, each showcase includes a command button or other object to allow flipping between front and back images of each document. Furthermore right clicking on a showcase image would display a shortcut menu offering the following commands: zoom in or out of the image, copy to clipboard, tag for future mass-copy, rotate image, and print image.

At the top of the screen additional buttons include a status indicator 446 for accepting a payment showcased on screen 430; a status indicator 448 for returning a payment to property management company; a status indicator 450 for keeping the document on line for later review; and a close button 452. In response to each of these buttons, online review processor 38 sends a corresponding command to middle pass processor 12 for proper allocation of the payment at payment service center 60 or via ACH instruction process 40. Thus, the exemplary screen 430 in Fig. represents the stored images of various pieces of a specific correspondence received at payment service center 60 that contained 2 coupons (real or virtual), 4 checks, an envelope and two pages of correspondence.

Field 454 of screen 430 provides an explanation of the reasons an item is provided for Online Review or Return mode. This includes any rule violations listed in the corresponding CCT table, such as commercial third party checks, government checks, money orders, unexpected DDAs and so on. It also includes the Hawkeye confirm designation as set forth by Hawkeye process 104 (FIG. 1) that forces an online review when a check is processed for payment.

Stop File matches are prominently displayed by an additional red “Stop Sign” icon. As such, if a check is received and in accordance with the corresponding CCT table, the check should not be deposited a “Stop Sign” appears on the screen to put the property management company on notice.

In accordance with another embodiment of the invention, online review process 38 allows an online reviewer to employ clicking or drag and drop mapping function between thumbnails so as to match specific checks displayed on screen 430, with specific coupons. In accordance with one embodiment a user may draw a line from one check to a corresponding coupon to represent the relationship. This feature advantageously allows a user to review a correspondence that includes multiple checks and multiple coupons and match the corresponding items.

In accordance with yet another embodiment of the invention, online review process 38 allows an online reviewer to accept, reject or keep online a payment after a correspondence between a check and a coupon is established, by for example drawing a line. In that event, a matched item that is accepted would appear in green, a matched item that is not accepted would appear in red, and a matched item that is designated for keeping online would appear in yellow.

Search/Add virtual coupon command 456, in accordance with one embodiment of the invention, allows authorized users to search database 42, and for example, tenant file 88, to select a tenant record, which would produce a Virtual Coupon with the corresponding tenant and depository information. Any such coupons can then be mapped to checks on display and processed like any other coupon.

Audit trail function feature 458 allows a user to record the detail of any automated operational process or operator decisions that affect the transaction. For example, line items on an audit report allow the user to enter operator ID, data and time stamp of the action and brief system-generated description of the action.

Link button 460 retrieves a list of text message comments that operators may have made concerning their actions or thoughts. The link itself displays the number of current comments for the item. The list allows the user to view any past comments each of which stamped with operator ID, date and time. A user can then add another comment, which automatically stamps the user ID, date and time the comment was posted.

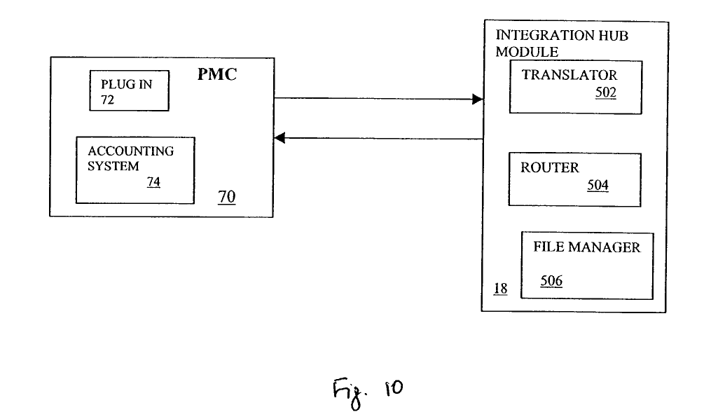

FIG. 9 illustrates the automatic clearing house (ACH) set up screen 480 in accordance with one embodiment of the present invention. As discussed earlier in reference with FIG. 5 one way to set up an ACH transaction is to employ check reader 82. Electronic payment processor 24 generates screen 480 in response to a scan of a check performed by check reader 82. It is noted that ACH set up screen 480 can also be generated in response to a check received via payment service center 60, or in response to instructions from tenant 98.

As illustrated, portion 482 of the screen relates to the tenant information. Button 490 allows a tenant search function to begin, by displaying a standard search screen as those known in the art. A user may then complete the search fields and click the SEARCH button, so that a tenant listing screen appears. The user can then select a desired tenant from the list of the tenants and return to ACH setup screen 480.

Portion 484 of screen 480 relates to rent billing file (RBF) information. In order to associate an ACH transaction with a tenant's most recent rent bill, a user clicks the RBF SEARCH button 492 to fill out a search request. In response an RBF listing screen appears. A user can then select the desired rent bill and return to the ACH setup screen.

Portion 486 relates to the transaction information. Thus, a user completes the fields available in that portion of screen 480. Specifically, the user completes the dollar amount for the ACH transaction, the frequency within which the ACH transaction is scheduled, for example, monthly recurring debit or one-time debit, date of payment, the date periodic payments end, account type, for example, checking or savings, check RTN number including Transit and Routing numbers provided by the scanned check, DDA number, which represents the bank account number as provided by the scanned check, check number as provided by the scanned check, ACH provider as provided from a drop down menu of a list of alternatives, and depository RTN/DDA, which represents the bank account associated with the tenant's building for depositing the payment.

In response to the above information, Electronic payment processor 24 updates its ACH scheduler and ACH receiver module so as to complete ACH transactions for the property management company, on behalf of the tenants.

Once an ACH transaction is set up, Electronic payment processor 24 provides this information to input buffer file 30, for processing by middle pass processor 12. As a result processor 12 applies the corresponding CCT rules to the ACH transaction to determine whether a payment is to be received or stopped or kept for online review. If the ACH entry meets the acceptable criteria, an ACH transaction is generated and provided to ACH instruction process 40. In response, ACH instruction process 40 provides instructions to Electronic payment processor 24, which in turn is transmitted to bank 92 via ACH receive module 94. Bank 92 in response completes the transaction and credits the account of the property management company.

In accordance with another embodiment of the invention, a tenant 98 can authorize payments via a credit or debit card in a manner as discussed in reference with Electronic payment processor 24 explained above. As such, the tenant's payment information is forwarded to middlepass processor 12 via input buffer file 30 to apply the rules contained in Check Criteria Template (CCT) 280 (FIG. 4). Once approved, collection processor 10 sends the information to bank 92 for processing the transaction and crediting the appropriate account number of a corresponding property management company.

FIG. 10 illustrates the operation of integration hub 18 (FIG. 1) in more detail. Data transfer module 72 interacts with accounting system 74 so as to retrieve the necessary information to update and maintain building master file 76, rent billing file 78 and stop file 80. Data transfer module 72 in accordance with one embodiment of the invention converts the information contained in these files into XML format for transmission to integration hub 18.

Integration hub 18 includes a translator module 502 configured to translate both the XML and CSV files into a format that complies with system requirements of collection processor 10. In applications wherein integration hub 18 is located remotely from collection processor 10, a router 504 is configured to set up the routing information so as to transmit the translated files to collection processor 10. A file manager 506 reviews the file information to determine whether they are valid. If so, the files are then provided for use by collection processor 10. Otherwise, integration hub 18 sends a message to property management system 70 indicating that the received files were not valid.

Once collection processor 10 processes a payment the updated information files, such as rent billing file, building master file, and stop file are sent back to property management system 70 via integration hub 18. Data transfer module 72 then interacts with accounting system 74 to update the information contained therein.

Thus, in accordance with various embodiments of the present invention, a completely automated payment collection process is provided, so as to interact with a property management accounting system, for processing payments made by check, credit cards, or ACH process. The system further applies collection criteria as specified by the corresponding property management company.

We claim:

1. A method for processing payments on behalf of a plurality of clients, each client controlling a plurality of entities, said payments made by a plurality of customers, said method comprising the steps of:
receiving a payment information corresponding to a customer;
storing a plurality of criteria sets for processing said payments made by said customers, wherein a first set of criteria is applied to an entity and a second set of criteria is applied to a client;
applying said first set of criteria to each of said payment information;
applying said second set of criteria to each of said payment information; and
generating instructions corresponding to each payment for processing each of said payments.

2. A method in accordance with claim 1 further comprising the step of storing a third set of criteria applied to a customer.

3. A method in accordance with claim 1 wherein said client is a property management company, said entity is a building managed by said property management company and a customer is a tenant living in said building.

4. A method in accordance with claim 3 further comprising the step of receiving said criteria for payment processing from a plurality of third party management companies.

5. A method in accordance with claim 1 wherein said step of receiving payment information further comprises the step of receiving scanned images of payment instruments.

6. A method in accordance with claim 5 wherein said step of receiving payment information further comprises the step of receiving instructions for processing an electronic payment transaction.

7. A method in accordance with claim 6 further comprising the step of scheduling said electronic payment transaction for periodic payments.

8. A method in accordance with claim 1 further comprising the step of transmitting said generated instructions to a payment service center for processing payment instruments sent by said customers.

9. A method in accordance with claim 8 wherein said step of generating instructions further comprises the step of generating instructions indicating an acceptance of a payment, and transmitting said generated instructions to said payment service center.

10. A method in accordance with claim 8, wherein said step of generating instructions further comprises the step of generating instructions indicating a denial of a payment, and transmitting said generated instructions to said payment service center.

11. A method in accordance with claim 8, wherein said step of generating instruction further comprises the step of generating instructions indicating an image of said payment instrument is displayed for online review.

12. A method in accordance with claim 8 further comprising the step of generating a review screen for displaying images of all documents sent by a customer as part of a payment.

13. A method in accordance with claim 12 wherein said displayed images include an image of envelope containing said documents.

14. A method in accordance with claim 8 further comprising the step of identifying a customer in accordance with information provided on said customer's payment instrument.

15. A method in accordance with claim 14 further comprising the step of identifying a payer in accordance with a payment coupon corresponding to said payer's current outstanding balance.

16. A method in accordance with claim 15 further comprising the step of generating an image of a payment coupon based on information obtained from said payment instrument.

17. A method in accordance with claim 3 further comprising the steps of providing a data transfer module to a plurality of property management systems for generating a building master file, a rent billing file and a stop file.

18. A method in accordance with claim 17 further comprising the step of updating said property management system in accordance with processing of each of said received payment instruments.

19. A method in accordance with claim 18 further comprising the step of receiving information corresponding to Automated Clearing House (ACH) transactions in response to said property management system scanning information from a check provided by a payer.

20. A method for receiving a plurality of correspondence from customers including payment instruments on behalf of a plurality of clients, each client controlling at least one entity, said method comprising the steps of:
receiving said correspondence from a post office in a plurality of mail batches, each of said batches corresponding to a unique post office box number that is assigned to a corresponding client;
extracting documents contained in each of said correspondence, including said payment instruments;
providing a batch header document, having a batch header identification information to identify each received batch;
scanning information contained on each received payment instrument and each received coupon statement;
allocating a unique sequence number to each scanned payment instrument and corresponding coupon statement;
storing a plurality of criteria sets for processing said payments made by said customers, wherein a first set of criteria is applied to a customer and a second set of criteria is applied to an entity and a third set of criteria is applied to a client;
receiving instructions from a collection processor system in response to said first, second and third set of criteria for accepting a plurality of said payment instruments for deposit and rejecting other plurality of said payment instruments for deposit, and holding other plurality of said payment instruments for online review; and
delivering to a bank said payment instruments accepted for deposit.

21. The method in accordance with claim 20 further comprising the step of storing in a safe deposit module payment instruments and corresponding coupons that need to be reviewed by a payee.

22. The method in accordance with claim 21 further comprising the step of storing said scanned images of said payment instruments and coupon statement in a database.

23. The method in accordance with claim 22 further comprising the step of preparing deposit slips for all those payment instruments that have been accepted for deposit.

24. The method in accordance with claim 23 further comprising the step of recognizing character amount on a payment instrument.

25. The method in accordance with claim 24 further comprising the step of recognizing legal amount on a payment instrument.

26. The method in accordance with claim 25 further comprising the step of displaying images of payment instruments that were not successfully recognized.

27. The method in accordance with claim 26 further comprising the step of conducting a balancing procedure for comparing amount set forth on a coupon statement with amount actually paid as indicated on said payment instrument.

28. A method for processing payments on behalf of a plurality of clients, each client controlling at least one entity, said payments made by a plurality of customers, said method comprising the steps of:
receiving a payment information corresponding to a customer;
providing a criteria definition interface, including a set of selectable options so as to define a plurality of desired criteria sets when each option is selected, said desired criteria sets configured to be associated with at least one of said customers and said entity and said client;
storing said plurality of criteria sets for processing said payments made by said customers, wherein a first set of criteria when defined is applied to a customer and a second set of criteria when defined is applied to an entity and a third said of criteria when defined is applied to a client; and
generating instructions corresponding to each payment for processing each of said payments.

29. The method in accordance with claim 28, wherein said client comprises a property management company.

30. The method in accordance with claim 29, wherein said entity comprises a building controlled by said property management company.

31. The method in accordance with claim 30, wherein said customer is a tenant residing in said building.

32. The method in accordance with claim 31, wherein said step of receiving payment information further comprises the step of receiving payment instruments from said tenants.

33. The method in accordance with claim 32, wherein said step of receiving payment information further comprises the step of receiving ACH payment instructions on behalf of said tenants.

34. The method in accordance with claim 33, wherein said step of receiving payment information further comprises the step of receiving electronic fund transfer instructions on behalf of said tenants.

35. The method in accordance with claim 30 further comprising the step of consolidating financial information corresponding to a plurality of accounting system applications operated by each of said clients.

36. The method in accordance with claim 30 wherein said step of providing selectable options to define a criteria set further comprises the step of providing a first option for accepting a payment a second option for rejecting a payment and a third option for allowing on-line review of a payment in accordance with occurrence of a certain event corresponding to a payment made by a customer.

37. The method in accordance with claim 36 further comprising the step of defining overpay and underpay tolerances for payments received from said customers.

38. The method in accordance with claim 37 further comprising the step of sending a confirmation message to said client, when a payment is successfully processed.

39. The method in accordance with claim 30 further comprising the step of identifying each customer based on demand deposit account (DDA) information provided on said customer's payment information.

40. The method in accordance with claim 39 further comprising the step of receiving said DDA information in response to the step of scanning an image of said customer's payment instrument.

41. The system in accordance with claim 30 wherein said clients comprise at least one from a group of property management companies, utility companies, and cable companies.
